(19) United States
(12) Patent Application Publication
(10) Pub. No.: US 2026/0316359 A1
(43) Pub. Date: Oct. 15, 2026

(54) APPARATUS FOR GENERATING PROCESS AIR AND METHOD FOR DEMOULDING MOULDED PARTS FOR INJECTION MOULDING MACHINES

(71) Applicant: NETSTAL Maschinen AG, Naefels (CH)

(72) Inventor: Daniel SPALINGER, Ossingen (CH)

(21) Appl. No.: 19/119,095

(22) PCT Filed: Sep. 7, 2023
(86) PCT No.: PCT/EP2023/074577

§ 371 Date: Apr. 7, 2025

(30) Foreign Application Priority Data
Oct. 5, 2022 (DE) 10 2022 125 634.0

(51) Int. Cl. B29C 45/43; B29C 45/82

(52) U.S. Cl. CPC B29C 45/43; B29C 45/82; B29C 2045/822; B29C 2945/76498

(57) ABSTRACT

An apparatus for providing process air at at least two different pressure levels for an injection moulding machine with an injection mould. The apparatus has a serial arrangement of two valves the first valve being connected on the one hand to a first pressure source with a first pressure level and on the other hand to an air duct which leads into the injection mould, and the second valve is connected to a second pressure source with a second pressure level and a vent line, wherein the first and second valves are designed and can be actuated in such a way that the air duct can be subjected to either the first or the second pressure. Furthermore, an injection moulding machine with such an apparatus, a method for demoulding moulded parts with the aid of such an apparatus and a use of such an apparatus are disclosed.

### BACKGROUND OF THE INVENTION

The invention relates to a fluid-technical apparatus for applications on injection moulding machines that require process air and for which high demands are placed on the reproducibility of demoulding. This is particularly the case in the manufacture of sealing caps, but it can also relate to other applications. The present invention relates in particular to an apparatus for generating or controlling process air, which can be used, for example, for manufacturing open hollow bodies, e.g. rotational bodies or cup-shaped moulded parts (injection moulded parts, also known as moulded parts), such as bottle closures. According to the invention, the process air is used at two different pressures. Thus, for example, first of all, for curving the base of the open hollow moulded parts (i.e. for shaping the base), pre-compression air is used at a first pressure and for the subsequent ejection process from the injection mould by blowing off or blowing out the moulded parts for demoulding, blowing air is used at a second pressure, which has a different value than the first pressure.

In recent years, plastic closures have become established in the beverage industry. These are mainly produced on injection moulding machines. During production on the injection moulding machine, these closures are ejected from the injection mould in free fall after reaching dimensional stability. As the closures are mass-produced, not just one but several cavities are filled per production cycle, which are arranged both next to and on top of each other. Depending on the type of moulded part or the closure principle, there are differences in the nature of the cavity and the type of ejection. At the beginning of the production of plastic closures, the state of the art was to unscrew the mould from the closures. As this takes up valuable cycle time, today the closures are forcibly demoulded where geometrically possible. This means that they are pressed off the thread of the core, partly with mechanical and partly with pneumatic support.

The ejection process and the resulting drop pattern of the caps during ejection influence the process reliability and/or the cycle time of the injection moulding machine, whereby both a high process reliability and a short cycle time improve the yield and throughput of the injection moulding process.

Compressed air is often used during the injection moulding process of the closures. On the one hand, the so-called pre-air during the demoulding phase is a technical process requirement for releasing the cap from the core by bulging the cap. For this purpose, compressed air is introduced between the closure and the core in the parting plane between the core end face and the closure body remote from the thread when the mould is closed. This makes it easier to detach the cap from the core, as the resulting vacuum is overcome. If the cap is then mechanically detached from the core, in some cases the process air is used via the same air connection to distance the caps relative to the cavity by activating the compressed air for a short time close to the ejection process. This helps to ensure that the caps do not hit the mould parts and therefore leave the injection mould safely in free fall towards the conveyor belt. However, the main ejection process is mechanical. The ejector is moved forwards at the same speed as the mould closure. The moving side of the mould is then moved away as quickly as possible towards the rear end position. This creates a drop pattern similar to a waterfall. In existing injection moulding machines, the pressure of the process air is usually always the same, i.e. the supply air and the blowing air have the same pressure.

It is state of the art that the produced closures are ejected during the opening movement of the injection mould, thus saving valuable cycle time. The additional use of blowing air helps to distance the closures from the injection mould and thus increases process reliability.

The ejection process is time-critical. The desired, straight drop pattern is subject to various physical influencing variables. The closures should always fall out of the injection mould with the same drop pattern once the process has been set. If this process is disturbed or subject to fluctuations, process reliability suffers. Such fluctuations in the pressure of the blowing air can be caused by all kinds of actuators in the clamping unit, in the ejector or in the blowing air control system and can be of a physical or control-related nature. Fluctuations in the process air due to changing pressures and air flow times can lead to the caps no longer falling as desired. The way in which the caps fall can be influenced by the air pressure and the actuation time of the pneumatic valve. However, this blowing process is subject to narrow limits. If the caps fall into the air flow of the next lower cavity, they rotate, are swirled or are blown too strongly in the direction of the injection mould half on the nozzle side. This is why blow air is rarely used to blow off the closures. If the control of the blowing air is too short, the closure is not blown off. Variations in the air control and the associated unpredictable behaviour increase the probability of a process malfunction.

Because the pneumatic valves used today traditionally have to manage two processes with just one pressure, on the one hand as pre-compression air for curving the base of the closures and on the other hand as blowing air for ejecting and spacing the closures relative to the moving injection mould half, the demands on the reproducibility of the pneumatic valves and all axes involved are very high.

There is therefore a need in the field of injection moulding machines for (alternative) apparatuses and methods that lead to improved (e.g. more reliable) or simpler demoulding of moulded parts than with the means currently known.

### SUMMARY OF THE INVENTION

Consequently, one task of the present invention is to provide an apparatus for providing process air for injection moulding machines, with which improved demoulding of the moulded parts can be achieved.

An apparatus according to the invention for an injection moulding machine with an injection mould, which serves to provide process air at a first pressure and a second pressure which is different (i.e. higher or lower) from the first pressure, comprises a serial arrangement of two valves, the first valve being connected on the one hand to a first pressure source with the first pressure and on the other hand to an (air) duct which leads into the injection mould, and the second valve being connected to a second pressure source with the second pressure and to a vent line, the first and second valves being designed and controllable in such a way that the (air) duct can each be acted upon either with the first pressure or with the second pressure.

The idea of the invention and the difference of the invention compared to known solutions is the use of two different, (pre-)adjustable pressures (or pressure levels) using the same pneumatic connection between the valve plate and the injection mould. Although the injection mould only has one effective duct for the purpose of introducing process air (e.g. on the one hand for curving the moulded parts and for breaking the negative pressure/vacuum in the area between the moulded parts and the surface of the injection mould using pre-air and on the other hand for blowing off the moulded parts using blast air), which can of course also be present several times, the invention enables the production process with two separately (pre-)adjustable air supplies via one valve. This has the advantage of extended adjustability, which increases the process window and reduces scattering, because fluctuations in the actuators or machine control are less relevant in the drop pattern, as the pressures for each process step (pre-air for cambering and blast air for ejection) can be set separately (in advance).

The apparatus according to the invention comprises an interlinking or sequential connection (in series) of two independently switchable valves (valve I and valve Il in FIG. 2), whereby valve I is connected downstream of the other valve Il in such a way that, in its basic position, it supplies the injection mould with the pressure of valve II if the latter is actuated. This means that the injection mould can be supplied with different pressures via both the upstream and downstream valves, each with a different pressure supply. Both valves must never be actuated at the same time, but this is never the case in the production process and is ensured by a corresponding control of the two valves, especially as there should be no high overpressure in the cavity when the injection mould is opened.

In one embodiment of the apparatus, the two valves are 3/2-way valves, which have three connections and two switching positions. The 3/2-way valves each have a first connection for connection to a supply line, a second connection for connection to a working line and a third connection for connection to a vent of the working line. In a first switching position, the first connection is closed and a passage from the second to the third connection is open and in a second switching position, the third connection is closed and a passage from the first to the second connection is open. In this case, the first connection of the first valve is connected to the first pressure source, the second connection of the first valve is connected to the (air) duct and the third connection of the first valve is connected to the second connection of the second valve. Furthermore, the first connection of the second valve is connected to the second pressure source and the third connection of the second valve is connected to the vent line for discharging (excess) process (exhaust) air.

In a further embodiment of the apparatus,, two or more serial arrangements of the two valves of a valve pair are connected in parallel, each of the first valves of the valve pairs being connected to the first pressure source, and each of the second valves of the valve pairs being connected to the second pressure source and, in particular, to the vent line, and each of the first valves of the valve pairs being connected to the injection mould, in particular via a separate channel. Alternatively, each of the second valves of the valve pairs can be connected to its own vent line.

With such a parallel arrangement of several pairs of valves, the process air can be fed into the injection mould via several air ducts and the process exhaust air can then be discharged from the injection mould in the case of a large injection mould in which a large number of moulded parts are produced simultaneously.

In a further embodiment of the apparatus, a further valve is connected in series between the first valve and the second valve (at least), wherein the further valve is connected to a further pressure source with a different (i.e. higher or lower or intermediate) further pressure compared to the first and second valves. This valve can therefore take on further tasks. The first, second and further valves are designed and can be controlled in such a way that the (air) ducts can be pressurised with either the first, the second or the further pressure. In particular, the further valve can be a 3/2-way valve. The first connection of the further valve is connected to the further pressure source, the second connection of the further valve is connected to the third connection of the first valve, and the third connection of the further valve is connected to the second connection of the second valve.

With such an interlinking or successive/serial connection of three or even more valves (beyond a valve pair to a “valve tuple”), it is possible to provide the process air at even more pressure levels (3, 4, etc.) in order to be able to realise correspondingly more complex (demoulding) processes.

In a further embodiment of the apparatus, the first pressure and/or the second pressure and/or any further pressure(s) can be adjusted. In this way, the pressures/pressure levels can be preset independently of each other according to the requirements, whereby they are then kept essentially constant during operation of the injection moulding machine. This means that the pressures/pressure levels are not changed during the process. It is therefore possible to introduce the process air into the injection mould at a selected pressure (from the preset pressures of the various pressure sources) by controlling the valves accordingly. Switching between different pressures can therefore be done much more quickly and more precisely than with a conventional system with only one pressure source and an adjustable pressure control valve.

In a further embodiment of the apparatus, the valves are electrically controllable, in particular solenoid valves.

In a further embodiment, the apparatus comprises a control unit which is designed to activate (open or close) only one of the first and second and possibly further valves in order to pressurise the channel with the first or second or possibly further pressure.

This means that the valves can be precisely controlled in the desired manner using an electric/electronic control unit and, for example, complex processes (with many valves) can be flexibly programmed and monitored. This can prevent undesirable situations in particular, thereby increasing process reliability.

The invention extends the possibility of influencing the process in additional respects, e.g. by connecting other components, as listed below.

In a further embodiment, the apparatus further comprises a compressed air accumulator which is connected to the first or second pressure source and the first or second valve, in particular the first connection of the first or second valve.

The blast air tract can be supported via this compressed air accumulator. This reduces a sharp drop in pressure during valve actuation (see FIG. 2 Valve I) and stabilises the air flow by decoupling the supply line.

In a further embodiment, the apparatus further comprises a non-return valve which is arranged in the vent line, in particular further comprising a silencer which is arranged in the vent line, wherein the non-return valve is arranged between the second valve and the silencer, wherein in particular a preload of the non-return valve is adjustable.

The venting of the pneumatic circuit usually has a silencer. It is possible to connect a non-return valve in between at this point. This would result in a spring pressure corresponding to the non-return valve being applied despite the pre-air valve being switched off (see FIG. 2 Valve II, connection 3). This reduces the air consumption and prevents the air duct in the injection mould from being completely emptied via the vent. The subsequent ejection process is therefore even more defined, as less air is required for the pressure build-up.

As a further aspect of the present invention, an injection moulding machine with an injection mould and an apparatus as specified above is proposed. The apparatus is connected to the injection moulding tool via one or more (air) ducts in order to be able to introduce process air into the injection moulding tool at at least two different pressures.

In one embodiment, the injection moulding machine further comprises one or more mechanical ejectors, for example in the form of a stripper ring, which are designed to detach moulded parts from the injection mould or from a surface of the injection mould and/or to eject moulded parts from the injection mould, in order to support a demoulding process of the moulded parts.

In one embodiment, the injection moulding machine is designed to produce open hollow bodies, such as rotational bodies or cup-shaped moulded parts, in particular to simultaneously produce a plurality of such moulded parts, wherein the injection mould has in particular a plurality of cavities, which are arranged in columns next to one another or in rows one above the other, for shaping the moulded parts.

As a further aspect of the present invention, a method is proposed for demoulding moulded parts, in particular open hollow bodies, such as rotational bodies or cup-shaped moulded parts, for example closures of bottles, from an injection mould in an injection moulding machine as specified above by means of an apparatus as specified above. Such a method according to the invention comprises the following steps subsequent to an injection process, in particular during a cooling phase of the moulded parts in the injection mould of the injection moulding machine:
Applying a pre-air pressure to the duct by opening a passage in a pre-air valve, which connects the pre-air source to the duct, and by (previously) closing a passage in a blast air valve, which connects a blast air pressure source to the duct, in particular to introduce pre-air with the pre-air pressure into the injection mould, in particular between the respective moulded part and a core of the injection mould when the injection mould is closed, in particular to curl the respective moulded part, in particular to break a vacuum between the respective moulded part and the core, in order to separate the moulded parts from the injection mould;
(subsequently) Applying a blast air pressure to the duct by opening a passage in the blast air valve which connects the blast air pressure source to the duct, and by (previously) closing a passage in the pre-air valve which connects the pre-air pressure source to the duct, in particular in order to introduce blast air with the blast air pressure into the injection mould, in particular into an interior of the open hollow moulded parts, such as rotational bodies or cup-shaped moulded parts, in order to blow the moulded parts out of the injection mould;
Venting the injection mould by closing the passage in the blow air valve, which connects the blow air pressure source to the duct, and by opening the respective passages in the pre-air and blow air valves, which connect the duct to the vent line. Here, the pre-air pressure can be either the second or first pressure in the apparatus and, conversely, the blast air pressure can be either the first or second pressure in the device. Thus, the pre-air source can be either the second or first pressure source in the apparatus and, conversely, the blast air source can be either the first or second pressure source in the apparatus. The pre-air valve can be either the second or first valve in the apparatus and, conversely, the blast air valve can be either the first or second valve in the apparatus.

In one embodiment, the method comprises at least one of the following two additional steps:
Actuation of a mechanical ejector to support the demoulding process, in particular during or after applying the pre-air pressure to the duct, in order to detach moulded parts from the injection mould or from a surface of the injection mould;
Actuation of a mechanical ejector to support the demoulding process, in particular before or during the application of the blow air pressure to the duct, in order to eject moulded parts from the injection mould.

In a further embodiment, the method also has the following additional step:
Supporting the blast air pressure via a compressed air accumulator to reduce a sharp drop in pressure during actuation of the blast air valve and to stabilise an air flow by decoupling a feeding blast air line (from the blast air source to the blast air valve).

In a further embodiment, the method also has the following additional step:
Generation of an (adjustable) spring pressure in the vent line by means of a non-return valve when the pre-air valve is switched off in order to reduce the consumption of process air and to prevent complete emptying of the duct (to and in particular in the injection mould) via the vent line.

It should be expressly noted that combinations of the above embodiments may form further embodiments of the invention (provided they do not contradict each other).

As a further aspect of the present invention, a use of the above-mentioned apparatus(for providing process air) for demoulding moulded parts, in particular open hollow bodies, such as rotational bodies or cup-shaped moulded parts, e.g. closures of bottles, from an injection mould during manufacture by means of an injection moulding machine is proposed.

### BRIEF DESCRIPTION OF THE DRAWINGS

Non-limiting embodiments of the present invention are explained in further detail below with reference to figures. They show:

FIG. 1 a schematic view (in the form of a pneumatic circuit or circuit diagram) of a prior art apparatus for providing process air for demoulding moulded parts in an injection moulding machine; and

FIG. 2 is a schematic view (in the form of a pneumatic circuit or circuit diagram) of an apparatus according to the invention for providing process air for demoulding moulded parts in an injection moulding machine (with several optional features).

In the figures, identical reference signs stand for identical elements.

### DETAILED DESCRIPTION OF THE INVENTION

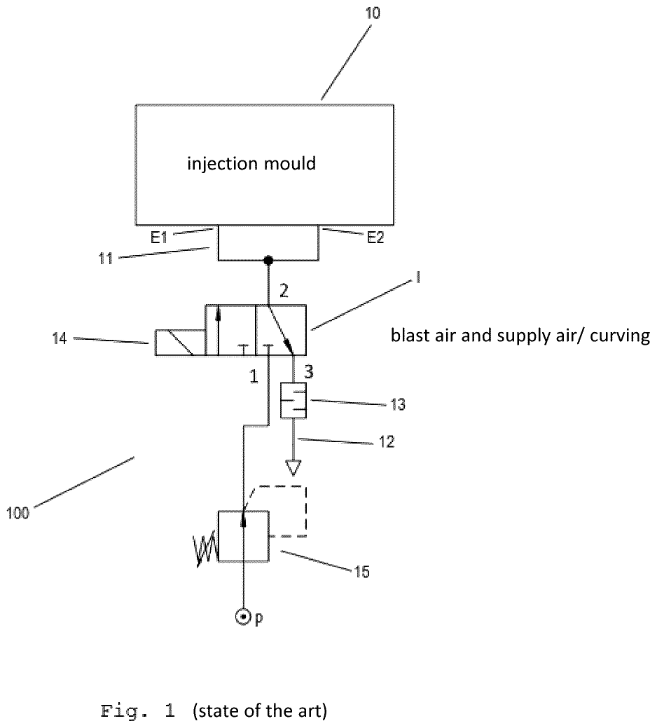

FIG. 1 shows a schematic view (in the form of a pneumatic circuit or a pneumatic circuit diagram) of a known apparatus for supplying process air for demoulding moulded parts in an injection moulding machine. Here, the process air is supplied from a single compressed air source p at a constant pressure. Based on this fixed output pressure of the compressed air source p, the pressure of the process air is adjusted (e.g. reduced) during the demoulding process by means of the (proportional) pressure control valve 15 according to the current requirements, which is then fed into the injection mould 10 via the single valve I and the (branched) duct 11 (via two process air inlets E1, E2). For this purpose, valve I is electrically actuated by a control unit so that the passage through valve I from port 1 to port 2 is opened for the process air. During the demoulding process, the pressure of the process air is reduced, e.g. by means of the pressure control valve 15, during the transition from pre-air for detaching the moulded parts from the surface of the injection mould 10 to blowing air for ejecting the moulded parts from the injection mould 10, whereby the passage through valve I from port 1 to port 2 remains open. The pressure change through the pressure control valve 15 is relatively slow, so that no rapid pressure drops can be achieved, for example. During the venting phase, the passage from port 1 to port 2 is closed and the passage from port 2 to port 3 is opened instead in order to discharge the process exhaust air through the vent line 12. It is channelled through a silencer 13 to reduce loud noises. As the process air is switched by a single valve I, it may be necessary for the duct 11 for supplying process air to the injection mould 10 to branch out to several connections (in FIG. 1 the air inlets E1 & E2) on the injection mould 10 (in FIG. 1 there are two branches). With this known apparatus, fluctuations in the process air due to changing pressures and flow times of the air, caused by the pneumatic section with the pressure control valve, can lead to the moulded parts not being ejected from the injection mould 10 as desired and thus falling out differently. In addition, suitable (proportional) pressure control valves are expensive, require a variable control signal and are less reliable than simple valves, which can only be opened or closed.

In order to eliminate these disadvantages and to eliminate or at least improve the scattering in the air control (with regard to the pressure of the process air and control times of the pneumatic valve) and the associated unpredictable behaviour in order to avoid process disturbances, embodiments of the device according to the invention for providing process air at different pressures for more reliable demoulding in injection moulding machines are described below.

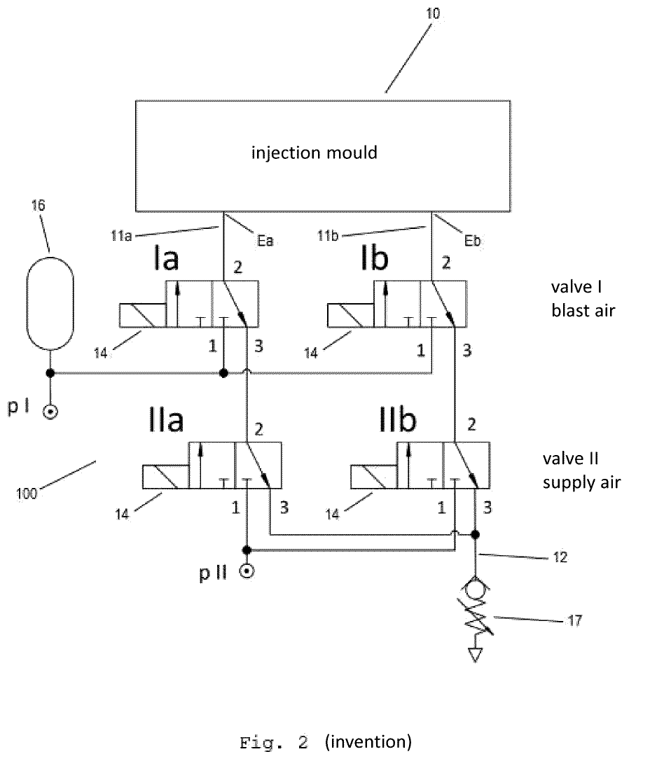

For example, FIG. 2 shows a schematic view (in the form of a pneumatic circuit or a pneumatic circuit diagram) of an apparatus 100 according to the invention for providing process air for demoulding moulded parts in an injection moulding machine (with several optional features). The apparatuse 100 comprises two valve pairs Ia, IIa and Ib, IIb, one of these two valve pairs being optional. The core of the invention is the serial arrangement shown in FIG. 2 and the corresponding pairwise interconnection of two valves each, whereby each valve Ia, IIa (or Ib, IIb) of the valve pair is connected to its own compressed air source (or process air source) pI, pII. The pressures of the two compressed air sources pI and pII are different, whereby they are preset (i.e. before the start of the process) and then kept fixed (i.e. essentially constant). For example, the blast air pressure of the blast air source pI for blowing the moulded parts out of the injection mould is (significantly) lower than the pre-air pressure of the pre-air source pII for cambering the moulded parts, with which the vacuum between the core of the injection mould and the moulded parts is broken and the moulded parts are detached from the surface of the injection mould. It should be noted at this point that the release process (as well as the ejection) is usually supported by mechanical ejectors, whereby the blow-off essentially serves to distance the moulded parts from the injection mould as desired, whereupon the moulded parts then fall safely out of the injection mould without touching it elsewhere. Correctly setting and maintaining the blow air pressure is particularly important for injection moulds that have a large number of cavities arranged in rows on top of each other (or next to each other in columns) for the simultaneous moulding of many moulded parts. In this case, it is important that blowing air from the lower cavities does not touch the falling moulded parts from higher cavities and, for example, press them against the opposite side of the injection mould. For certain applications, however, it is also conceivable that the blow air pressure is set (in advance) higher than the pre-air pressure.

In FIG. 2, the pressure source pII connected to the lower valve IIa is the pre-air source (for providing the pre-air pressure) and the pressure source pI connected to the upper valve Ia is the blast air source (for providing the blast air pressure). Accordingly, we refer to the lower valve IIa as the pre-air valve and the upper valve Ia as the blast air valve. However, the upper pressure source pI could also be the supply air source and the lower pressure source pII the blast air source. Accordingly, the upper valve Ia would then also be the pre-air valve and the lower valve IIa the blast air valve. It is typically advantageous if, as shown in FIG. 2, the blast air valve Ia is connected downstream of the pre-air valve IIa, as the pre-air pressure is usually (much) higher than the blast air pressure and there is a certain pressure drop as the process air flows through each valve. As there is only a very low flow rate through the two valves Ia, IIa for the supply air, the pressure drop is also very low. The blast air only flows through the blast air valve, which means that the pressure drop is also low.

The two valves are basically identical, except that the upper valve Ia is directly connected to the air duct 11a, which feeds the process air to the injection mould 10, while the lower valve IIa can be indirectly connected to the air duct 11a via the upper valve Ia. Conversely, the lower valve IIa is directly connected to the vent line 12, whereas the upper valve Ia can be indirectly connected to the vent line 12 via the lower valve IIa. Preferably, bistable valves should be used. In terms of signalling technology, the valves used are usually monostable, but electro-pneumatically pilot-controlled, whereby the main spool of the respective valve is pressed into a defined end position, causing the valves to act bistably. This guarantees that the supply air from the supply air valve flows through the blast air valve in a process-safe manner.

Both valves Ia, IIa are typically designed as 3/2-way valves, which have a first connection 1 for connection to a supply line (to the pressure source pI, pII), a second connection 2 for connection to a working line (to the injection mould 10) and a third connection 3 for connection to a venting of the working line (to the vent line 12).

The following process steps are carried out for demoulding moulded parts from the injection mould 10 in accordance with the invention following the injection process and, in particular, during the cooling phase of the moulded parts. First, the air duct 11a is pressurised with the pre-air pressure from the pre-air source pII. To do this, the passage from port 1 to port 2 in the pre-air valve IIa must be opened, and the passage from port 3 to port 2 in the downstream blast air valve Ia must also be opened. If both valves are electrically controllable so-called “normally closed” valves (i.e. closed in the basic position-as shown in FIG. 2) or so-called “normally open” valves (i.e. (i.e. open in the basic position) valves, the valve control will have to control the (lower) pre-air valve IIa the other way round than the (upper) blast air valve Ia, because in the case of blast air valve Ia the passage from port 1 to 2 must be closed when the passage from port 3 to 2 is open, and in the case of pre-air valve IIa the passage from port 1 to 2 must be open when the passage from port 3 to 2 is closed. By closing the passage from port 1 to 2 at the blast air valve Ia, the blast air source pI is not connected to the duct 11a and therefore not connected to the injection mould 10. On the other hand, by opening the passage from connection 1 to 2 at the pre-air valve IIa, the pre-air source pII is indirectly connected to the air duct 11a and thus to the injection mould 10 via the open passage from connection 3 to 2 at the blow air valve Ia, so that the pre-air pressure is present there. Due to the introduction of the pre-air at the pre-air pressure into the injection mould 10, which takes place between the moulded parts and the corresponding cores of the injection mould 10 when the injection mould 10 is closed, the moulded parts (in particular the bases of open hollow bodies, such as rotational bodies or cup-shaped moulded parts) bulge and a vacuum or negative pressure between the respective moulded part and the core is broken, so that the moulded parts detach from the injection mould 10 after a certain period of time of the pre-air supply.

As soon as the desired duration of the pre-air supply has elapsed, the passage from connection 1 to 2 at pre-air valve IIa is closed again by means of appropriate control of pre-air valve IIa, so that the pre-air source pII is disconnected from duct 11a. By closing the passage from port 1 to 2 at the pre-air valve IIa, the passage from port 2 to 3 at the pre-air valve IIa is (automatically) opened, which leads to the venting of the process exhaust air from the injection mould 10 via the air duct 11a and the open passage from port 2 to 3 at the blast air valve Ia into the vent line 12.

The air duct 11a is then pressurised with the blast air pressure from the blast air source pI. To do this, the passage from port 1 to port 2 in the blast air valve Ia must be opened, while the passage from port 1 to port 2 in the upstream pre-air valve IIa is closed (which is the case when port 2 to port 3 in the pre-air valve IIa is open), to connect the blast air source pI with the blast air pressure to the injection mould 10 in order to introduce blast air into the latter (in particular into an interior of moulded parts with an open hollow body) in order to blow the moulded parts out of the injection mould 10 or to distance the moulded parts from the injection mould 10 (typically assisted or even primarily effected by mechanical ejectors).

After the moulded parts have been blown out by the blast air supply for a desired period of time, the passage from port 1 to 2 at blast air valve Ia is closed again by means of appropriate control of blast air valve Ia, so that the blast air source pI is separated from duct 11a. Closing the passage from port 1 to 2 at blow air valve Ia (automatically) opens the passage from port 2 to 3 at blow air valve Ia, which leads to venting of the process exhaust air from the injection mould 10 via air duct 11a and the open passage from port 2 to 3 at pre-air valve IIa into the vent line 12.

Both the detachment of the moulded parts from the surface of the injection mould 10 and the blowing or ejection of the moulded parts from the injection mould 10 can be additionally supported by actuating a mechanical ejector (either both or only one of detachment and blowing/ejection).

Furthermore, a compressed air accumulator 16 can be used to support the blast air pressure, which is connected to the blast air supply line from the blast air source pI to connection 1 of the blast air valve Ia. This reduces a sharp drop in pressure during actuation of the blast air valve Ia and stabilises the air flow by decoupling the supplying blast air feed line.

Furthermore, a (adjustable) spring pressure can be generated in the vent line 12 by means of a non-return valve 17 when the pre-air valve IIa is switched off, which leads to a reduction in the consumption of process air and prevents the air duct 11a from being completely emptied via the vent line 12. In addition, the preload pressure set on the non-return valve 17 can (intentionally) extend the duration of the release process, even if the pre-air valve IIa has already been closed.

In the case of a large injection mould 10, for example in order to be able to simultaneously produce a large number of open hollow bodies, such as rotational bodies or cup-shaped moulded parts, e.g. closure caps, with a large number of cavities, which are arranged, for example, in columns next to one another or in rows one above the other, several air ducts 11a, 11b may be required for introducing process air into the injection mould 10. Instead of branching only one air duct (several times) and routing it to several connections E1, E2 on the injection mould 10, it can be advantageous to use several separate air ducts 11a, 11b in order to improve the process air supply. Each air duct 11a, 11b can be assigned its own valve pair Ia+IIa, Ib+IIb, as shown in FIG. 2. A first valve pair consisting of the blast air valve Ia and the upstream pre-air valve IIa operates the first air duct 11a. A second valve pair arranged in parallel, consisting of the blast air valve Ib and the upstream pre-air valve IIb, operates the second air duct 11b. The two pre-air valves IIa, IIb are connected to the common pre-air source pII, while the two blast air valves Ia, Ib are connected to the common blast air source pI. Both air ducts 11a, 11b are vented via a common vent line 12, although this could also be done via two separate vent lines. The two valve pairs Ia+IIa and Ib+llb are actuated in an identical manner, whereby the switching operations must be coordinated in detail depending on the size of the injection mould 10 in order to achieve the desired demoulding sequence. For example, in the case of a large injection mould with ten process air connections, ten parallel valve pairs can be used to optimise the process air supply. It should also be noted that smaller valves are more cost-effective and more dynamic (faster).

It is also possible to introduce a further valve between the first and the upstream second valve of a serially arranged valve pair in order to connect a third process air source, which supplies a different third pressure. In this way, further (4th, 5th, etc.) process air sources could also be connected and used in the demoulding process.

### LIST OF REFERENCE SIGNS

1 first valve connection for supply line
2 second valve connection for working line
3 third valve connection for venting (of the working line)
10 injection mould
11 (air) duct from the valve to the injection mould (with two air inlets into the injection mould)
11a (air) duct from valve Ia to the injection mould (with a first air inlet into the injection mould)
11b (air) duct from valve Ib to the injection mould (with a second air inlet into the injection mould)
12 vent/venting (line)
13 silencer
14 electrical control of the valve
15 adjustable pressure control valve
16 compressed air accumulator
17 non-return valve (spring-loaded, e.g. with adjustable preload)
100 apparatus for supplying process air
E1, E2 air inlet into the injection mould
Ea, Eb air inlet into the injection mould
I aalve, 3/2-way valve (with electric actuation) for supply air and blast air
Ia first valve of valve pair a, 3/2-way valve (with electrical actuation) for blast air
IIa second valve of valve pair a, 3/2-way valve (with electrical actuation) for supply air
Ib first valve of valve pair b, 3/2-way valve (with electrical actuation) for blast air
IIb second valve of valve pair b, 3/2-way valve (with electrical actuation) for supply air
p pressure (air) source with fixed (air) pressure
pI pressure (air) source with first fixed (air) pressure
pII pressure (air) source with second fixed (air) pressure≠first (air) pressure

1-17. (canceled)

18. An apparatus for an injection moulding machine with an injection mould for providing process air at a first pressure and a second pressure which is different in comparison therewith, wherein the apparatus has a serial arrangement of two valves, a first valve being connected on the one hand to a first pressure source with a first pressure and on the other hand to a duct, which leads into the injection mould, and a second valve is connected to a second pressure source with a second pressure and to a vent line, wherein the first and second valves are configured to be actuated in such a way that the duct can be subjected to either the first or the second pressure.

19. The apparatus according to claim 18, wherein the two valves are 3/2-way valves which each have a first connection for connection to a supply line, a second connection for connection to a working line and a third connection for connection to a vent of the working line, wherein the first connection of the first valve is connected to the first pressure source, the second connection of the first valve is connected to the duct, and the third connection of the first valve is connected to the second connection of the second valve, and wherein the first connection of the second valve is connected to the second pressure source, and the third connection of the second valve is connected to the vent line for discharging process air.

20. The apparatus according to claim 18, wherein two or more serial arrangements of the two valves of a valve pair are connected in parallel, each of the first valves of the valve pairs being respectively connected to the first pressure source, and each of the second valves of the valve pairs is connected in each case to the second pressure source and in particular to the vent line, and each of the first valves of the valve pairs is connected in particular to the injection mould via a separate duct.

21. The apparatus according to claim 18, wherein a further valve is serially interposed between the first valve and the second valve, wherein the further valve is connected to a further pressure source with a further pressure different from the first and second, wherein the first, second and further valves are designed and controllable in such a way that the duct can each be subjected to either the first, the second or the further pressure, wherein the further valve is in particular a 3/2-way valve, wherein in particular the first connection of the further valve is connected to the further pressure source, the second connection of the further valve is connected to the third connection of the first valve, and the third connection of the further valve is connected to the second connection of the second valve.

22. The apparatus according to claim 18, wherein the first pressure and/or the second pressure and/or the possibly further pressure is adjustable.

23. The apparatus according to claim 18, wherein the valves are electrically controllable, in particular in that the valves are solenoid valves.

24. The apparatus according to claim 18, further comprising a control unit which is designed to activate only one of the first and second and optionally further valves at a time in order to pressurize the duct with the first or second or optionally further pressure.

25. The apparatus according to claim 18, further comprising a compressed air accumulator which is connected to the first or second pressure source and the first or second valve, in particular the first port of the first or second valve.

26. The apparatus according to claim 18, further comprising a non-return valve which is arranged in the vent line, in particular still further comprising a silencer which is arranged in the vent line, wherein the non-return valve is arranged between the second valve and the silencer, wherein in particular a pretension of the non-return valve is adjustable.

27. An injection moulding machine with an injection mould and an apparatus as claimed in claim 18, wherein the apparatus is connected to the injection mould via one or more ducts in order to be able to introduce process air into the injection mould at at least two different pressures.

28. The injection moulding machine according to claim 27, further comprising one or more mechanical ejectors, for example in the form of a stripper ring, which are designed for detaching moulded parts from the injection mould or from a surface of the injection mould and/or for ejecting moulded parts from the injection mould, to support a demoulding process of the moulded parts.

29. The injection moulding machine according to claim 27, which is configured to produce open hollow bodies, such as rotational bodies or cup-shaped moulded parts, in particular in order to produce a plurality of such moulded parts simultaneously, wherein the injection mould has in particular a plurality of cavities, which are arranged in columns next to one another or in rows one above the other, for shaping the moulded parts.

30. A method for demoulding moulded parts, in particular open hollow bodies, such as rotational bodies or cup-shaped moulded parts, for example closures of bottles, from an injection mould in an injection moulding machine as claimed in claim 27, comprising the following steps subsequent to an injection process, in particular during a cooling phase of the moulded parts in the injection mould of the injection moulding machine:
applying a pre-air pressure to the duct by opening a passage in a pre-air valve, which connects the pre-air source to the duct, and by closing a passage in a blast air valve, which connects a blast air pressure source to the duct, in particular in order to introduce pre-air with the pre-air pressure into the injection mould, in particular between the respective moulded part and a core of the injection mould when the injection mould is closed, in particular in order to curl the respective moulded part, in particular in order to break a vacuum between the respective moulded part and the core, so as to separate the moulded parts from the injection mould;
applying a blast air pressure to the duct by opening a passage in the blast air valve, which connects the blast air pressure source to the duct, and by closing a passage in the pre-air valve, which connects the pre-air pressure source to the duct, in particular in order to introduce blown air with the blown air pressure into the injection mould, in particular into an interior of the open hollow bodies, such as rotary bodies or cup-shaped moulded parts, in order to blow the moulded parts out of the injection mould;
venting the injection mould by closing the passage in the blast air valve, which connects the blast air pressure source to the duct, and by opening the respective passages in the pre-air and blast air valves, which connect the duct to the vent line,
wherein the pre-air pressure is either the second or first pressure in the apparatus and the blast air pressure is conversely either the first or second pressure in the apparatus, and thus the pre-air source is either the second or first pressure source in the apparatus and the blast air source is conversely either the first or second pressure source in the apparatus, and wherein the pre-air valve is either the second or first valve in the apparatus and, conversely, the blast air valve is either the first or second valve in the device.

31. The method according to claim 30, wherein the injection moulding machine comprises one or more mechanical injectors, for example, in the form of a stripper ring, which are designed for detaching moulded parts from the injection mould or from a surface of the injection mould and/or for ejecting moulded parts from the injection mould, to support a demoulded process of the moulded parts, comprising at least one of the following two additional steps:
actuation of a mechanical ejector to support the demoulding process, in particular during or after the application of the pre-air pressure to the duct, in order to detach moulded parts from the injection mould or from a surface of the injection mould;
actuation of a mechanical ejector to support the demoulding process, in particular before or during the application of the blast air pressure to the duct, in order to eject moulded parts from the injection mould.

32. The method according to claim 30, comprising the following additional step:
Supporting the blast air pressure via a compressed air accumulator in order to reduce a sharp drop in pressure during actuation of the blast air valve and to stabilise an air flow by decoupling a feeding blast air line.

33. The method according to claim 30, comprising the following additional step:
generation of a spring pressure in the vent line by a non-return valve when the pre-air valve is switched off, in order to reduce the consumption of process air and to prevent complete emptying of the duct via the vent line.

34. The method according to claim 31, comprising the following additional step:
Supporting the blast air pressure via a compressed air accumulator in order to reduce a sharp drop in pressure during actuation of the blast air valve and to stabilise an air flow by decoupling a feeding blast air line.

35. The method according to claim 31, comprising the following additional step:
generation of a spring pressure in the vent line by a non-return valve when the pre-air valve is switched off, in order to reduce the consumption of process air and to prevent complete emptying of the duct via the vent line.

36. The method according to claim 32, comprising the following additional step:
generation of a spring pressure in the vent line by a non-return valve when the pre-air valve is switched off, in order to reduce the consumption of process air and to prevent complete emptying of the duct via the vent line.
